(19) United States
(12) Patent Application Publication
(10) Pub. No.: US 2010/0193449 A1
(43) Pub. Date: Aug. 5, 2010

(54) MATERIALS AND METHODS FOR REMOVING ARSENIC FROM WATER

(76) Inventors: Jian-Ku Shang, Mahomet, IL (US); Qi Li, Champaign, IL (US)

Correspondence Address: EVAN LAW GROUP LLC, 600 WEST JACKSON BLVD., SUITE 625, CHICAGO, IL, 60661, US

(21) Appl. No.: 12/364,505

(22) Filed: Feb. 2, 2009

(51) Int. Cl. C02F 1/68; B01J 27/24

(52) U.S. Cl. 210/763; 502/200

(57) ABSTRACT

A method of purifying water comprises contacting the water with a quaternary oxide while exposing the quaternary oxide to visible light, the quaternary oxide containing a dopant metal, a dopant nonmetal, titanium, and oxygen. The atomic ratio of titanium, oxygen and dopant nonmetal is 1:0.5-1.99:0.01-1.5.

### FEDERALLY SPONSORED RESEARCH OR DEVELOPMENT

The subject matter of this application may have been funded in part under a research grant from the National Science Foundation, under Grant Number CTS-0120978, Banner/UFAS 149646919110. The U.S. Government may have rights in this invention.

### BACKGROUND

Photocatalysts provide for catalysis of chemical reactions when irradiated by electromagnetic radiation. One advantage of photocatalysts is environmental stability, since they are relatively inert until subjected to irradiation. Photocatalysts have been investigated for applications in a variety of areas, including environmental remediation. Stable catalysts that promote oxidation reactions can oxidize pollutants in air and in water, including inorganic pollutants, organic pollutants and microorganisms. By breaking the pollutants down into substances that are less harmful, the need for storage or disposal of pollutants that have been extracted from air or water can be minimized.

Titanium oxide (TiO₂) in the anatase structure type is an example of a photocatalyst that is useful in many different applications. Titanium oxide is a semiconductor that is stable in a wide range of environmental conditions and that promotes oxidation-reduction (redox) reactions when irradiated with ultraviolet light. Systems utilizing titanium oxide and ultraviolet radiation have been used for commercial water purification. In addition, titanium oxide has been investigated and/or used for applications including air purification, hydrogen production by the photochemical splitting of water, nitrogen fixation, odor control, antimicrobial surface coatings, and self-cleaning surface coatings.

One drawback to the use of titanium oxide as a photocatalyst is the requirement for irradiation by ultraviolet light, due to its large band gap. Since ultraviolet radiation is only a small portion of solar radiation once it has passed though the atmosphere, titanium oxide has a low photon yield when exposed to sunlight. Doping of titanium oxide with other elements can provide for a narrowing of the band gap, allowing for increased reactivity under visible light. These doped materials do not necessarily provide for increased oxidation of pollutants under visible light, however. Possible explanations for the low oxidation efficiency include rapid recombination of the electron-hole pairs before oxidation can occur, and the short lifetimes of the charge carrying dopants. In addition, doped titanium oxide typically is expensive to produce and is difficult to obtain in large enough quantities for use in environmental remediation facilities.

Arsenic contamination in natural water poses a great threat to millions of people in many regions of the world (1, 2). Arsenic is a widely distributed element in nature, and can get mobilized into groundwater/surface water from soils and ores through both natural process and/or anthropogenic activities (3, 4). Chronic arsenic poisoning can cause a lot of human health problems through either contaminated drinking water or agriculture products irrigated by contaminated water. Studies have demonstrated that chronic exposure to arsenic can lead to liver, lung, kidney, bladder, and skin cancers (5, 6), cause cardio vascular system problems (7), and affect the mental development of children (8). Accordingly, the U.S. Environmental Protection Agency (USEPA) revised the maximum contaminant level (MCL) for arsenic in drinking water from 50 to 10 μg/L in 2001 and required compliance with this level since January 2006 (9).

Most arsenic pollution in natural water exists as two major species, namely As(III) (arsenite) or As(V) (arsenate). Several techniques have been established for arsenic removal from contaminated water sources, including coagulation-precipitation processes, membrane processes, and adsorption/ion exchange processes (10), which remove As(V) from water effectively. Although it has been demonstrated that As(III) has higher affinity than As(V) to certain adsorbents (11), it is generally reported that As(III) does not have high affinity to the surface of various adsorbents compared with As(V) because As(III) exists mainly as nonionic H₃AsO₃ in natural water with pH value ranging from weakly acidic to weakly alkaline (12-14). Thus, the removal of As(III) remains a challenge and a pretreatment of As(II) by oxidizing it to As(V) before coagulation-precipitation or adsorption processes is necessary for its effective removal from water (10, 15-18). Many oxidants have been tested to oxidize As(III) to As(V), including oxygen and/or ozone (19), hydrogen peroxide (20), chlorine (21), manganese dioxide (22, 23), KMnO₄ (12), UV/H₂O₂(24), UV/Fe(III) complexes (25, 26), Fe(II)/H₂O₂ (27), potassium ferrate (28), and UV/TiO₂ (13, 24, 29-34). Since the first report by Rajeshwar and co-workers in 1999 (24), many efforts have been made on the photocatalytic oxidation of As(III) with TiO₂ under UV light illumination because it could provide a relatively low-cost and robust approach, without either the addition of corrosive materials or the possible production of toxic disinfection byproduct (DBPs) or disinfection byproduct precursors (DBPPs). The proposed oxidation mechanisms of As(III) in the UV/TiO₂ system range from reactions with oxidative species of .OH and/or h⁺ (24), O₂.^{*-}/HO₂. (13, 29, 30), .OH (31) to direct hole oxidation (33).

### SUMMARY

In a first aspect, the invention provides a method of purifying water, comprising contacting the water with a quaternary oxide while exposing the quaternary oxide to visible light. The quaternary oxide contains a dopant metal, a dopant nonmetal, titanium, and oxygen. The atomic ratio of titanium, oxygen and dopant nonmetal is 1:0.5-1.99:0.01-1.5.

In a second aspect, the invention provides a method of oxidizing As(III) to As(V), comprising contacting a solution containing As(III) with a quaternary oxide while exposing the quaternary oxide to visible light. The quaternary oxide contains a dopant metal, a dopant nonmetal, titanium, and oxygen. The atomic ratio of titanium, oxygen and dopant nonmetal is 1:0.5-1.99:0.01-1.5.

In a third aspect, the invention provides a method of removing arsenic from water, comprising contacting the water with a quaternary oxide while exposing the quaternary oxide to visible light. The quaternary oxide contains a dopant metal, a dopant nonmetal, titanium, and oxygen. The atomic ratio of titanium, oxygen and dopant nonmetal is 1:0.5-1.99:0.01-1.5, and the dopant nonmetal is nitrogen.

In a fourth aspect, the invention provides a catalyst for oxidizing As(III) to As(V), containing a dopant metal, a dopant nonmetal, titanium, and oxygen. The atomic ratio of titanium, oxygen and dopant nonmetal is 1:0.5-1.99:0.01-1.5, and the dopant nonmetal is nitrogen.

The following definitions are included to provide a clear and consistent understanding of the specification and claims.

The term “quaternary oxide” means a substance containing oxygen and at least three other elements.

The term “titanium source” means a substance containing titanium that is soluble in a solvent.

The term “dopant nonmetal” means a nonmetal element that is not oxygen; for example boron, carbon, nitrogen, fluorine, silicon, phosphorus, sulfur, chlorine, germanium, arsenic, selenium, bromine, antimony, tellurium, iodine or astatine.

The term “dopant nonmetal source” means a substance containing a nonmetal element that is not oxygen, and optionally containing other elements. For example, a dopant nonmetal source may contain boron, carbon, nitrogen, fluorine, silicon, phosphorus, sulfur, chlorine, germanium, arsenic, selenium, bromine, antimony, tellurium, iodine and/or astatine.

The term “dopant metal” means a metal element that is not titanium; for example, an element having an atomic number of 13, 20, 21, from 23 to 31, from 38 to 50, or from 56 to 83.

The term “dopant metal salt” means a substance containing a metal that is not titanium, and that can provide a source of ions of the metal, where the metal ion is an ion of an element having an atomic number of 13, 20, 21, from 23 to 31, from 38 to 50, or from 56 to 83. Dopant metal salts include, for example, salts of the metal and oxides of the metal.

The term “polar organic solvent” means a non-aqueous solvent having a dielectric constant at 25° C. of at least 10.

The term “calcination” means heating a substance at a temperature below its melting point, sufficient to cause growth of grains. Preferably the heating temperature is at least halfway between 0° C. and the melting temperature of the lowest melting component in the substance.

The term “photocatalysis” means a catalysis that is dependent on the presence of electromagnetic radiation to catalyze a reaction.

The term “visible light” means electromagnetic radiation having a wavelength of 380 nm to 780 nm.

The term “oxidation-reduction reaction” means a chemical reaction between two species involving the transfer of at least one electron from one species to the other species. This type of reaction is also referred to as a “redox reaction.” The oxidation portion of the reaction involves the loss of at least one electron by one of the species, and the reduction portion involves the addition of at least one electron to the other species.

### BRIEF DESCRIPTION OF THE DRAWINGS

The invention can be better understood with reference to the following drawings and description. The components in the figures are not necessarily to scale, emphasis instead being placed upon illustrating the principles of the invention.

FIG. 1 depicts a method of making a quaternary oxide.

FIG. 2 depicts a method of making a quaternary oxide by a sol-gel procedure.

FIG. 3 depicts a method of making a quaternary oxide by a hydrothermal procedure.

FIG. 4 depicts a method of coating a surface with a quaternary oxide.

FIG. 5 is a graph of bacteria survival fraction versus time for Escherichia coli (E. coli) on coated and uncoated stainless steel surfaces.

FIG. 6 is a graph of bacteria survival percentage versus time for E. coli on coated and uncoated stainless steel surfaces.

FIG. 7 is a graph of bacteria survival ratio versus time on coated and uncoated stainless steel surfaces for Pseudomonas aeruginosa.

FIG. 8 is a graph of bacteria survival ratio versus time on coated and uncoated stainless steel surfaces for Staphylococcus aureus.

FIG. 9 is a graph of methylene blue concentration versus time for a variety of coated surfaces.

FIG. 10 is a graph of humic acid concentration versus time for a variety of coated surfaces.

FIGS. 11A-FIG. 11D are a sequence of images for a fingerprint on a glass slide coated with a quaternary oxide.

FIG. 12 is a graph of normalized resistance over time for quaternary oxide nanofibers, with alternate introduction of a nitrogen gas stream and a gas stream containing 1,000 ppm hydrogen.

FIG. 13 is a graph of resistance over time for quaternary oxide nanofibers, with alternate introduction of an oxygen gas stream and a gas stream containing 1,000 ppm carbon monoxide.

FIG. 14(a) is an X-ray diffraction pattern of TiON/PdO nanoparticle photocatalysts.

FIG. 14(b) is a TEM image of TiON/PdO nanoparticle photocatalysts.

FIG. 15 is a representative XPS survey spectrum of TiON/PdO nanoparticles. The inset plot illustrates the high-resolution XPS scan spectrum over Pd 3d spectral region of TiON/PdO nanoparticles.

FIG. 16 is a diffuse reflectance spectra of Degussa P25 TiO2 nanoparticles, TiON nanoparticles, and TiON/PdO nanoparticles.

FIGS. 17(a) and (b) are graphs of adsorption kinetics of (a) As(III) and (b) As(V) on TiON/PdO nanoparticles. The lines are the pseudo-second-order rate model fittings.

FIGS. 18(a)-(f) are graphs of arsenic species concentrations versus treatment time under various conditions: (a)-(c) with initial As(III) concentration at 1.02 mg/L, and (d)-(f) with initial As(III) concentration at 0.455 mg/L.

### DETAILED DESCRIPTION

The present invention makes use of the discovery that quaternary titanium oxides (titanium oxide doped with a metal and a nonmetal) may exhibit efficient photocatalysis of redox reactions. A small amount of dopant is sufficient to provide photocatalytic oxidation of organic compounds and bacteria, among other reactions. In addition, it has been discovered that titanium oxide may be doped with metals and/or nonmetals by methods that are less expensive than conventional doping methods and that can be performed on a large scale. These methods may be performed at relatively low temperatures, and the doped titanium oxide products may be coated onto a variety of surfaces.

Of particular interest in the present application is the removal of arsenic from water. The quaternary titanium oxides, especially titanium oxide doped with a metal and nitrogen, act as photocatalysts for the oxidation of As(III) to As(V), under visible light illumination. Furthermore, the quaternary titanium oxides also strongly absorb both As(III) and As(V). This combination of absorption and photocatalytic oxidation allows for the efficient removal of arsenic from water.

A method of making a quaternary oxide includes heating a mixture of substances containing titanium, oxygen, a dopant nonmetal and a dopant metal. Other substances or elements may be present in the mixture, such as halides, hydrogen, etc., provided that they volatilize or phase separate from the mixture during heating. The titanium may be present in the mixture as an oxide, a sulfide, a halide, an alkoxide, a nitrate, and/or an oxysulfate. The oxygen may be present in the mixture as part of a compound with titanium, such as a titanium oxide, a titanium alkoxide, and/or a titanium oxysulfate. The dopant nonmetal may be present in the mixture as a hydrogen compound such as ammonia or an ammonium salt, ammonium bifluoride, a borohydride, or hydrogen sulfide. The dopant nonmetal may be present in the mixture as a metal compound such as a metal nitride, a metal sulfide, or a metal oxide. The dopant nonmetal may be present in the mixture as a component of a salt such as a sulfate or a carbonate. The dopant nonmetal may be present in the mixture as an organic compound, such as an amine, an alcohol, a carboxylic acid, an aldehyde, a ketone, a sulfone, a sulfoxide, or a fluorocarbon. The dopant metal may be present in the mixture as an oxide, a sulfide, a halide, an alkoxide, a nitrate, or an oxysulfate.

A variety of synthetic methods may be used, including conventional solid phase synthesis, sol-gel methods, solvothermal methods, etc. Preferably the components are intimately mixed prior to heating, such as by being dissolved in a common solvent or, when in the solid phase, by repeated grinding and heating.

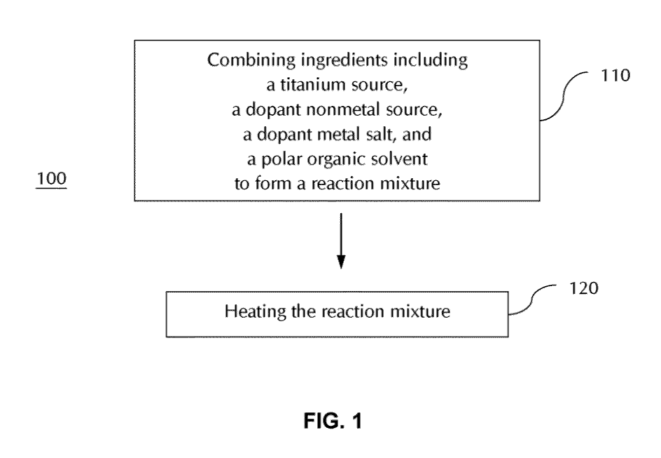

FIG. 1 represents an example of a solvothermal method 100 of making a quaternary oxide that includes combining ingredients including a titanium source, a dopant nonmetal source, a dopant metal salt, and a polar organic solvent to form a reaction mixture 110; and heating the reaction mixture 120. Combining ingredients 110 may include mixing the ingredients in any order. Combining ingredients 110 also may include adding other ingredients to form the reaction mixture. A quaternary oxide formed by the method may contain a dopant metal, a dopant nonmetal, titanium and oxygen.

The titanium source may be any titanium compound or complex, including an oxide, a sulfide, a halide, an alkoxide, a nitrate, and an oxysulfate. Preferably the titanium source is a titanium(IV) halide, a titanium(IV) alkoxide, a titanium(IV) nitrate or a titanium(IV) oxysulfate. More preferably the titanium source is a titanium(IV) alkoxide.

The dopant nonmetal source may be a hydrogen compound, a metal compound, a component of a salt, or an organic compound. Preferably the dopant nonmetal source includes boron, carbon, nitrogen, sulfur, fluorine, or a combination of these elements. More preferably the dopant nonmetal source includes nitrogen.

The dopant metal salt may be an oxide, a sulfide, a halide, an alkoxide, a nitrate, or an oxysulfate. Preferably the dopant metal salt contains an ion of calcium, cobalt, nickel, copper, gallium, strontium, yttrium, zirconium, palladium, silver, tin, lanthanum or platinum.

The polar organic solvent may be any non-aqueous solvent having a dielectric constant at 25° C. of at least 10. Preferably the polar organic solvent has a boiling point at one atmosphere pressure of at least 100° C. More preferably the polar organic solvent has a dielectric constant at 25° C. of at least 25 and a boiling point at one atmosphere pressure of at least 150° C. Preferably the polar organic solvent is ethylene glycol.

Other ingredients may include water, a surfactant, or a surface-directing agent. One or more of these other ingredients may be combined with the titanium source, dopant nonmetal source, and dopant metal salt to form the reaction mixture. One or more of these other ingredients may be combined with one or two of the titanium source, the dopant nonmetal source and dopant metal salt, and then combined with the remaining ingredient or ingredients to form the reaction mixture. One or more of these other ingredients may be added to the reaction mixture just prior to heating the reaction mixture.

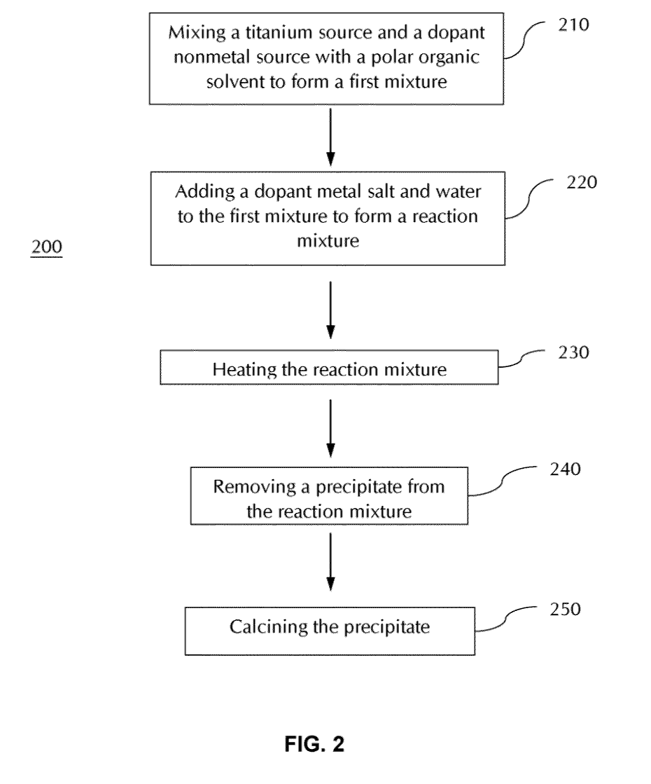

FIG. 2 represents a method 200 of making a quaternary oxide by a sol-gel procedure that includes mixing a titanium source and a dopant nonmetal source with a polar organic solvent to form a first mixture 210, adding a dopant metal salt and water to the first mixture to form a reaction mixture 220, heating the reaction mixture 230, removing a precipitate from the reaction mixture 240, and calcining the precipitate 250. Heating the reaction mixture 230 may include heating the reaction mixture at a temperature of from 50° C. to 250° C. for at a period of at least 4 hours. Preferably the reaction mixture is heated at a temperature of from 70° C. to 1 50° C. for a period of from 5 hours to 48 hours, and preferably at a temperature of from 70° C. to 150° C. for a period of at least 12 hours. Removing a precipitate from the reaction mixture may include conventional separation methods, such as filtration and/or centrifugation. The precipitate may include a quaternary oxide containing a dopant metal, a dopant nonmetal, titanium and oxygen.

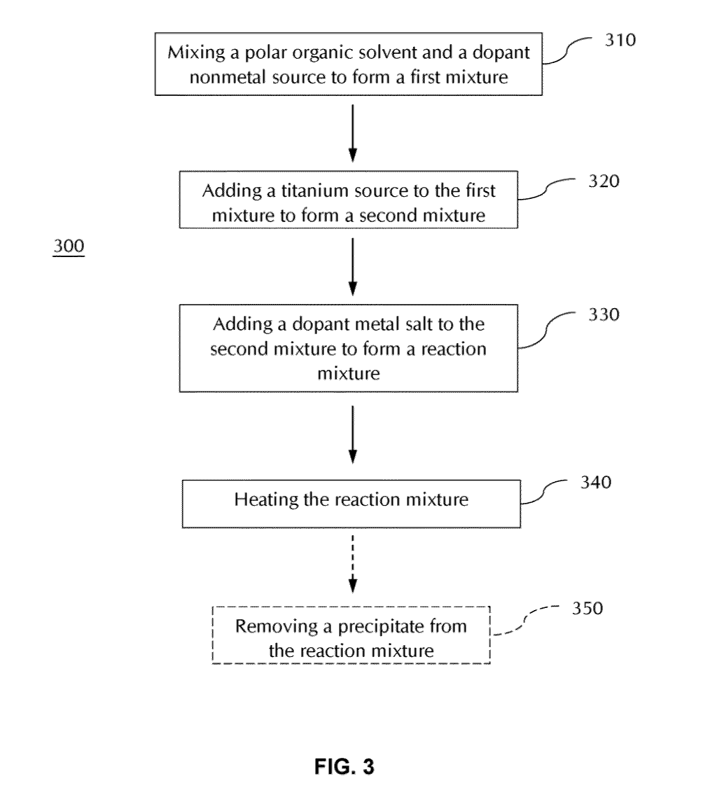

FIG. 3 represents a method 300 of making a quaternary oxide by a hydrothermal procedure that includes mixing a polar organic solvent and a dopant nonmetal source to form a first mixture 310, adding a titanium source to the first mixture to form a second mixture 320, adding a dopant metal salt to the second mixture to form a reaction mixture 330, heating the reaction mixture 340, and optionally removing a precipitate from the reaction mixture 350. Adding a dopant metal salt to the second mixture may include adding water to the second mixture. Heating the reaction mixture 340 may include heating the reaction mixture in an autoclave at a temperature of from 100° C. to 350° C. for at least 4 hours. Preferably the reaction mixture is heated at a temperature of from 150° C. to 300° C. for a period of from 5 hours to 48 hours, and preferably at a temperature of from 205° C. to 250° C. for a period of at least 5 hours. After heating, the reaction mixture may include a quaternary oxide containing a dopant metal, a dopant nonmetal, titanium and oxygen.

A quaternary oxide containing a dopant metal, a dopant nonmetal, titanium and oxygen may be characterized in terms of its elemental composition. The atomic ratio of titanium to oxygen to dopant nonmetal (Ti:O:A) may be 1:0.5-1.99:0.01-1.5. Preferably the TI:O:A atomic ratio is 1:1.0-1.99:0.01-1.0; more preferably is 1:1.5-1.99:0.01-0.5, and more preferably is 1:1.9-1.99:0.01-0.1. Preferably the dopant nonmetal is boron, carbon, nitrogen, sulfur or fluorine. More preferably the dopant nonmetal is nitrogen.

The quaternary oxide may contain the dopant metal at a concentration of at most 10 percent by weight (wt %). Preferably the quaternary oxide contains the dopant metal at a concentration of at most 5 wt %, more preferably at a concentration of at most 2 wt %. Preferably the dopant metal is calcium, cobalt, nickel, copper, gallium, strontium, yttrium, zirconium, palladium, silver, tin, lanthanum or platinum.

In addition to the elemental composition, the quaternary oxide may be characterized by a number of other properties. The crystal structure of the quaternary oxide may be characterized by X-ray diffraction, electron diffraction, neutron diffraction, electron microscopy, examination of physical and chemical properties, and/or by other well known methods. Preferably the quaternary oxide is in the anatase structure type (anatase phase). The band gap of the quaternary oxide may be characterized by spectroscopic analysis. The energy of absorbed radiation having the longest wavelength corresponds to the band gap energy. Preferably the quaternary oxide has a band gap less than 3.0 electron-volts (eV).

A catalytic composition may include the quaternary oxide containing a dopant metal, a dopant nonmetal, titanium and oxygen, where the atomic ratio of titanium to oxygen to dopant nonmetal (Ti:O:A) is 1:0.5-1.99:0.01-1.5. The catalytic composition may be characterized by the rate of conversion of a chemical reaction when the reactants of the reaction are in contact with the composition. When an organic substance is in contact with the composition and is irradiated with visible light, the concentration of the organic substance may be reduced by 40% within 4 hours. When bacteria are in contact with the composition and are irradiated with visible light, the concentration of living bacteria may be reduced by 20% within 1 hour.

The catalytic composition may be present on a support. Examples of support materials include glass, ceramic, metal, plastic and paper. The support may be porous or non-porous. Examples of porous supports include a mat of fibers, a zeolite, or a porous film. The term “on a support” includes when the composition is on at least a portion of a surface of the support. For porous supports, the term “on a support” further includes when the composition is present within the pores of the support.

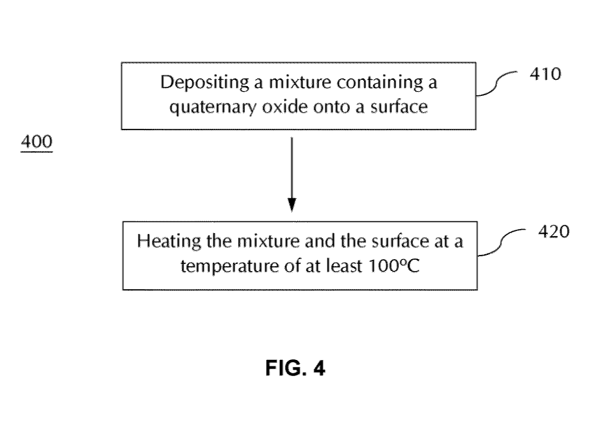

FIG. 4 represents a method 400 of coating a surface with a quaternary oxide that includes depositing a mixture containing a quaternary oxide onto a surface 410, and heating the mixture and the surface at a temperature of at least 100° C. 420. The method may be repeated one or more times to provide a coating of the desired thickness and/or quality.

Depositing a mixture of a quaternary oxide onto a surface 410 may include combining the quaternary oxide with a liquid to provide the mixture, and applying the mixture to the surface. Depositing a mixture 410 may include applying to the surface at least a portion of a reaction mixture containing the quaternary oxide, where the reaction mixture has been prepared by a hydrothermal process. Depositing a mixture 410 also may include spinning the surface as the mixture is applied. The mixture may include other ingredients, such as a surfactant, a coupling agent or a pH buffer. Examples of other mixture ingredients include aluminum phosphate (AIPO₄), silane compounds such as 3-glycidoxypropyltrimethoxysilane, and fluoroalkyl-silane compounds such as (tridecafluoro-1,1,2,2-tetrahyd rooctyl)-trichlorosilane.

Heating the mixture and the surface 420 may include heating in air, heating in a vacuum, or heating in an inert atmosphere. The temperature of the heating may be varied depending on factors including the surface to be coated, the heating atmosphere, the type of quaternary oxide, and the coating mixture composition. For example, a glass substrate may be coated with a quaternary oxide containing palladium, titanium, oxygen and nitrogen (Pd—Ti—O—N) by spin coating a mixture containing the quaternary oxide onto the substrate, followed by heating the coated glass in air at 400° C. for one hour. In another example, a stainless steel substrate may be coated with a Pd—Ti—O—N quaternary oxide by spin coating a mixture containing the quaternary oxide and AlPO₄ onto the substrate, followed by heating the coated substrate in air at 200° C. for 30 minutes. In another example, a stainless steel substrate may be coated with a Pd—Ti—O—N quaternary oxide by spin coating a mixture containing the quaternary oxide and either a silane or fluoroalkyl-silane onto the substrate, followed by heating the coated substrate in air at 140° C. for 30 minutes.

The catalytic composition may be present without a support. For example, the catalytic composition may be in the form of a powder, beads, fibers, or a porous film. The catalytic composition may also be present in one or more of these forms on a support. These forms may include nanoparticles. Nanoparticles containing titanium oxide are described, for example in U.S. Provisional Patent Application Ser. No. 60/754,680, entitled “Nanoparticles Containing Titanium Oxide”, filed Dec. 29, 2005, which is incorporated by reference.

Quaternary oxides can be used in a variety of applications. Examples of possible applications include catalysis, water and air purification, gas sensing, hydrogen production, solar energy production, fiber lasers, additives for composites and fabrics, and cancer therapy. In general, any application that can utilize titanium oxide, titanium oxide doped with a metal, and/or titanium oxide doped with a nonmetal may also utilize a quaternary oxide. One advantage of quaternary oxides over these conventional materials is the high catalytic efficiency of quaternary oxides under visible light rather than UV light. Thus, applications of the conventional materials that require UV irradiation may be performed under visible light using a quaternary oxide.

Catalytic compositions including a quaternary oxide may be used to facilitate a wide variety of reactions. For example, a catalytic composition may be mixed with a reactant fluid and irradiated with visible light, providing for a chemical reaction of one or more ingredients of the fluid. The catalytic composition may then be recovered from the fluid and recycled for use in another portion of reactant fluid. Depending on the application and the composition of the dopants in the quaternary oxide, catalytic compositions containing a quaternary oxide may be used in place of general metal catalysts such as cobalt, nickel, copper, gold, iridium, lanthanum, nickel, osmium, platinum, palladium, rhodium, ruthenium, silver, strontium, yttrium, zirconium and tin.

In another example, a catalytic composition may be present on a support, and a fluid may flow in contact with the support and the composition. In this configuration, the catalytic composition may be exposed to a constant stream of fluid and does not require separation of the composition from the fluid after the reaction is performed. For example, a catalytic composition may be present on a support in an automobile exhaust system, where the exhaust system has been fitted with a visible light source, such as a fiber optic light source or an LED light source. Irradiation of the catalytic composition during operation of the automobile engine may provide for degradation of organics and other pollutants from the engine into environmentally acceptable substances.

In another example, a catalytic composition may be present on a surface that is exposed to dirt, grease and other organic and inorganic contaminants. Such a surface may be “self-cleaning” when exposed to visible light. Self-cleaning glass may have a transparent or translucent coating of a catalytic composition on one or both sides of the glass. Contaminants that contact the glass may then be degraded when the glass is exposed to visible light. It may be desirable for self-cleaning glass to have a hydrophilic surface, to provide for rinsing of any remaining degradation products from the glass with water. Examples of self-cleaning glass having surface coatings of TiO₂ include SunClean® glass (PPG Industries, Pittsburgh, Pa.) and Activ™ glass (Pilkington, Toledo, Ohio). A self-cleaning surface having a coating containing a quaternary oxide may also remove fingerprints from the surface automatically upon exposure to visible light.

In another example, a catalytic composition may be present on a surface that is exposed to microbes, such as bacteria and fungi, and/or to viruses. Such a surface may be a “disinfecting surface” by destroying or inactivating microbes or viruses that are present on the surface. For example, surfaces in residential, commercial or hospital environments may have a coating of a catalytic composition on the surface. Examples of surfaces that may be made into disinfecting surfaces include countertops, flooring, walls, handles, telephones, and surfaces of medical instruments.

A catalytic composition also may be applied to a surface to provide a temporary disinfection of the surface. For example, a catalytic composition may be part of a cleaning composition in the form of a liquid, a foam or a lotion. Application of the cleaning composition to a surface, followed by exposure of the surface to visible light, may cause the destruction or inactivation of microbes or viruses that are present on the surface. Such cleaning compositions may be formulated for use on skin to provide a disinfecting personal care product.

Catalytic compositions including a quaternary oxide may be used for air and/or water purification. For example, a catalytic composition may be mixed with contaminated air or water and irradiated with visible light. Contaminants in the air or water may be degraded into substances that are volatile or that are more easily separated from the fluid. For example, contaminants containing organic substances and halogenated substances may be degraded into carbon dioxide and halide ions, which may then be separated from the air or water. In the case of air purification, the degradation of contaminants may also result in control of odors in the air.

The quaternary titanium oxides, especially titanium oxide doped with a metal and nitrogen, act as photocatalysts for the oxidation of As(III) to As(V), under visible light illumination. Furthermore, the quaternary titanium oxides also strongly absorb both As(III) and As(V). This combination of absorption and photocatalytic oxidation allows for the efficient removal of arsenic from water. The quaternary titanium oxide may be contacted with water containing arsenic, such as water containing As(IIII), As(V) or most likely, both. The quaternary titanium oxide may be present as a powder, a foam, fibers coated with the quaternary titanium oxides, etc., and allowed to come into contact with the water containing arsenic and exposed to visible light, such as artificial light or sunlight. Existing systems for oxidation and/or removal of arsenic from water that use TiO₂ and UV radiation may also be used, substituting the TiO₂ with the quaternary titanium oxide, and exposure to visible light rather than UV radiation. Examples of water purification systems that use TiO₂ and UV radiation include the Photo-Cat® system (Purifics® ES Inc., London, Ontario, CA) and the water treatment system from Matrix Photocatalytic, Inc. (London, Ontario, CA). Similarly, the same substitution of TiO₂ with the quaternary titanium oxide, and exposure to visible light instead of UV radiation, may be used with air purification systems; examples of air purification systems that use TiO₂ and UV radiation include the air treatment system from Matrix Photocatalytic, Inc.

Quaternary oxides may be used for sensing gases. The electrical conductivity of quaternary oxides may vary depending on the chemical composition of their environment, and this variable conductivity may provide for the use of quaternary oxides to measure the type and/or amount of one or more gases. The electrical resistance of the quaternary oxide or a material containing the quaternary oxide may be measured in an environment and compared with the electrical resistance in a control environment. The difference between the measured resistance and the control resistance may be correlated with the amount and/or identity of a gas in the environment. These conductivity variations may be especially pronounced for fibers of quaternary oxides or for particles that have been sintered, and it may be desirable to use fibers or sintered materials for sensing applications. Examples of gases that may be identified and/or measured include hydrogen, carbon monoxide, hydrogen sulfide, and water. Preferably a gas sensor using a quaternary oxide can be used to sense gases at ambient conditions.

Quaternary oxides may be used for the production of hydrogen and oxygen from water. Splitting of water into hydrogen gas and oxygen gas using TiO₂ and UV radiation is described, for example, in T. Bak et al., International Journal of Hydrogen Energy, 27, 991-1022 (2002). Water may be decomposed into hydrogen and oxygen by photocatalysis with a catalytic composition containing a quaternary oxide, when irradiated with visible light. This decomposition also may be carried out in a photo-electrochemical cell having a photo-anode containing a quaternary oxide. It may be desirable to use a photo-electrochemical cell, as this can provide for separate collection of hydrogen and oxygen from the cell.

Quaternary oxides may be used for the production of electricity from solar radiation. Solar cells containing TiO₂ and a dye for sensitizing the TiO₂ are described, for example, in S. K. Deb, Solar Energy Materials & Solar Cells, 88, 1-10 (2005). Electric current may be produced when dye molecules are excited by exposure to light, transferring electrons into the conduction band of quaternary oxide particles. The quaternary oxide particles may conduct the electrons to a current collector that is connected to an electrical circuit with a load.

Quaternary oxide fibers may be used for fiber lasers. The quaternary oxide material may be used for one or more components of a laser, such as the laser cavity, gain medium, Bragg grating and fiber couplings. Quaternary oxides may have a direct bandgap and can thus be used to emit light.

Quaternary oxides may be used as additives in composite materials, including polymer composites, fabrics and nonwoven materials. For example, quaternary oxide fibers may be incorporated with other fibers into textile fabrics. These fabrics may provide for degradation of contaminants in contact with the fabric when exposed to visible light, resulting in self-cleaning or disinfecting fabrics. In another example, the ability to vary the composition of quaternary oxides may provide for optimized interactions of quaternary oxide particles or fibers with a composite matrix.

Quaternary oxides may be used as bioactive agents. In an aqueous environment, such as within an organism, a quaternary oxide that is irradiated with visible light may produce hydroxyl ions (OH⁻), superoxide ions (O₂⁻), and/or hydrogen peroxide (H₂O₂). A quaternary oxide that is exposed to visible light while in a cell or in contact with a cell may produce a toxic environment and damage or kill the cell. Thus, quaternary oxides may be used as anti-cancer agents when delivered to tumor cells. The use of TiO₂ and UV radiation as an anti-cancer agent is described, for example, in R. Cai et al., Cancer Research, 52, 2346-2348 (1992). It may be desirable to couple the quaternary oxide to a targeting agent that is selectively absorbed by tumor cells. Light may be delivered laparoscopically to the cells containing the quaternary oxide, resulting in cell death or a reduction in cell growth or propagation.

The following examples are provided to illustrate one or more preferred embodiments of the invention. Numerous variations may be made to the following examples that lie within the scope of the invention.

### EXAMPLES

### Example 1

### Sol-Gel Synthesis of Pd—Ti—O—N Quaternary Oxide

Titanium tetraisopropoxide (Ti(OCH(CH₃)₂)₄, 14 g, reagent grade 98+%) and tetramethylammonium hydroxide (N(CH₃)₄⁺[OH⁻], 9 g, 25% in methanol) were dissolved in 50 ml ethanol. Palladium(II) acetylacetonate (Pd(C₅H₇O₂)₂, 150 mg) dissolved in 2 mL dichloromethane was mixed with 20 mL water, and this mixture was added to the ethanol solution gradually. The reaction mixture was maintained at 70° C. for 12 hours. The precipitate from the reaction mixture was removed, washed with water, and calcined at 500° C. for 3 hours. All reagents and solvents were obtained from ALDRICH (Milwaukee, Wis.).

### Example 2

### Sol-Gel Synthesis of Ag—Ti—O—N Quaternary Oxide

Titanium tetraisopropoxide (10 g) and tetramethylammonium hydroxide (6 g) were dissolved in 50 ml ethanol. Silver nitrate (AgNO₃, 100 mg) dissolved in 2 mL water was mixed with 20 mL water, and this mixture was added to the ethanol solution gradually. The reaction mixture was maintained at 70° C. for 12 hours. The precipitate from the reaction mixture was removed, washed with water, and calcined at 500° C. for 3 hours. All reagents and solvents were obtained from ALDRICH.

### Example 3

### Sol-Gel Synthesis of Y—Ti—O—N Quaternary Oxide

Titanium tetraisopropoxide (10 g) and tetramethylammonium hydroxide (7 g) were dissolved in 50 ml ethanol. Yttrium(III) acetylacetonate (Y(C₅H₇O₂)₃, 200 mg) dissolved in 2 mL dichloromethane was mixed with 20 mL water, and this mixture was added to the ethanol solution gradually. The reaction mixture was maintained at 70° C. for 12 hours. The precipitate from the reaction mixture was removed, washed with water, and calcined at 500° C. for 3 hours. All reagents and solvents were obtained from ALDRICH.

### Example 4

### Sol-Gel Synthesis of Pt—Ti—O—N Quaternary Oxide

Titanium tetraisopropoxide (10 g) and tetramethylammonium hydroxide (6 g) were dissolved in 50 ml ethanol. Platinum(II) acetylacetonate (Pt(C₅H₇O₂)₂, 10 mg) dissolved in 2 mL dichloromethane was mixed with 20 mL water, and this mixture was added to the ethanol solution gradually. The reaction mixture was maintained at 70° C. for 12 hours. The precipitate from the reaction mixture was removed, washed with water, and calcined at 500° C. for 3 hours. All reagents and solvents were obtained from ALDRICH.

### Example 5

### Sol-Gel Synthesis of Sr—Ti—O—N Quaternary Oxide

Titanium tetraisopropoxide (10 g) and tetramethylammonium hydroxide (6 g) were dissolved in 50 ml ethanol. Strontium carbonate (Sr(CO₃), 12 mg) dissolved in 2 mL methanol was mixed with 20 mL water, and this mixture was added to the ethanol solution gradually. The reaction mixture was maintained at 70° C. for 12 hours. The precipitate from the reaction mixture was removed, washed with water, and calcined at 500° C. for 3 hours. All reagents and solvents were obtained from ALDRICH.

### Example 6

### Sol-Gel Synthesis of W—Ti—O—N Quaternary Oxide

Titanium tetraisopropoxide (10 g) and tetramethylammonium hydroxide (6 g) were dissolved in 50 ml ethanol. Ammonium tungstate ((NH₄)ₓ(WO₄)_{y}, 12 mg) dissolved in 2 mL dichloromethane was mixed with 20 mL water, and this mixture was added to the ethanol solution gradually. The reaction mixture was maintained at 70° C. for 12 hours. The precipitate from the reaction mixture was removed, washed with water, and calcined at 500° C. for 3 hours. All reagents and solvents were obtained from ALDRICH.

### Example 7

### Sol-Gel Synthesis of Cu—Ti—O—N Quaternary Oxide

Titanium tetraisopropoxide (10 g) and tetramethylammonium hydroxide (6 g) were dissolved in 50 ml ethanol. Copper(II) acetylacetonate (Cu(C₅H₇O₂)₂, 500 mg) dissolved in 10 mL dichloromethane was mixed with 20 mL water, and this mixture was added to the ethanol solution gradually. The reaction mixture was maintained at 70° C. for 12 hours. The precipitate from the reaction mixture was removed, washed with water, and calcined at 500° C. for 3 hours. All reagents and solvents were obtained from ALDRICH.

### Example 8

### Sol-Gel Synthesis of Nd—Ti—O—N Quaternary Oxide

Titanium tetraisopropoxide (10 g) and tetramethylammonium hydroxide (6 g) were dissolved in 50 ml ethanol. Neodymium(III) acetylacetonate (Nd(C₅H₇O₂)₃, 120 mg) dissolved in 2 mL dichloromethane was mixed with 20 mL water, and this mixture was added to the ethanol solution gradually. The reaction mixture was maintained at 70° C. for 12 hours. The precipitate from the reaction mixture was removed, washed with water, and calcined at 500° C. for 3 hours. All reagents and solvents were obtained from ALDRICH.

### Example 9

### Sol-Gel Synthesis of Ni—Ti—O—N Quaternary Oxide

Titanium tetraisopropoxide (10 g) and tetramethylammonium hydroxide (6 g) were dissolved in 50 ml ethanol. Nickel(II) acetylacetonate (Ni(C₅H₇O₂)₂, 120 mg) dissolved in 2 mL dichloromethane was mixed with 20 mL water, and this mixture was added to the ethanol solution gradually. The reaction mixture was maintained at 70° C. for 12 hours. The precipitate from the reaction mixture was removed, washed with water, and calcined at 500° C. for 3 hours. All reagents and solvents were obtained from ALDRICH.

### Example 10

### Sol-Gel Synthesis of Co—Ti—O—N Quaternary Oxide

Titanium tetraisopropoxide (10 g) and tetramethylammonium hydroxide (6 g) were dissolved in 50 ml ethanol. Cobalt(II) acetylacetonate (Co(C₅H₇O₂)₂, 120 mg) dissolved in 2 mL dichloromethane was mixed with 20 mL water, and this mixture was added to the ethanol solution gradually. The reaction mixture was maintained at 70° C. for 12 hours. The precipitate from the reaction mixture was removed, washed with water, and calcined at 500° C. for 3 hours. All reagents and solvents were obtained from ALDRICH.

### Example 11

### Sol-Gel Synthesis of V—Ti—O—N Quaternary Oxide

Titanium tetraisopropoxide (10 g) and tetramethylammonium hydroxide (6 g) were dissolved in 50 ml ethanol. Vanadium(III) acetylacetonate (V(C₅H₇O₂)₃, 120 mg) dissolved in 2 mL dichloromethane was mixed with 20 mL water, and this mixture was added to the ethanol solution gradually. The reaction mixture was maintained at 70° C. for 12 hours. The precipitate from the reaction mixture was removed, washed with water, and calcined at 500° C. for 3 hours. All reagents and solvents were obtained from ALDRICH.

### Example 12

### Hydrothermal Synthesis of Ti—O—N Ternary Oxide

Ethylene glycol (HO—CH₂—CH₂—OH, 50 mL) was dried at 140° C. for 1 hour with vigorous stirring in a flask under a nitrogen atmosphere. Ethylene diamine (NH₂—CH₂—CH₂—NH₂, 5 mL) was dehydrated with MgSO₄ and added to the ethylene glycol. The mixture was stirred for 5 minutes, and then titanium tetraisopropoxide (5 mL) was added, followed by stirring for an additional 5 minutes. Deionized water (2 mL) was added to the mixture, and the reaction mixture was then transferred to a poly(tetrafluoroethylene)-lined stainless steel autoclave. The reaction mixture was heated to a temperature of 205-250° C. for 5-12 hours, and then cooled to room temperature. The precipitate from the reaction mixture was filtered and washed three times with ethanol. All reagents and solvents were obtained from ALDRICH.

### Example 13

### Hydrothermal Synthesis of Pd—Ti—O—N Quaternary Oxide

Ethylene glycol (50 mL) was dried at 140° C. for 1 hour with vigorous stirring in a flask under a nitrogen atmosphere. Ethylene diamine (5 mL) was dehydrated with MgSO₄ and added to the ethylene glycol. The mixture was stirred for 5 minutes, and then titanium tetraisopropoxide (5 mL) was added, followed by stirring for an additional 5 minutes. Deionized water (2 mL) and a solution of palladium(II) acetylacetonate (Pd(C₅H₇O₂)₂, 50 mg) in 2 mL dichloromethane were added to the mixture, and the reaction mixture was then transferred to a poly(tetrafluoroethylene)-lined stainless steel autoclave. The reaction mixture was heated to a temperature of 205-250° C. for 5-12 hours, and then cooled to room temperature. The precipitate from the reaction mixture was filtered and washed three times with ethanol. All reagents and solvents were obtained from ALDRICH.

### Example 14

### Hydrothermal Synthesis of Ag—Ti—O—N Quaternary Oxide

Ethylene glycol (50 mL) was dried at 140° C. for 1 hour with vigorous stirring in a flask under a nitrogen atmosphere. Ethylene diamine (5 mL) was dehydrated with MgSO₄ and added to the ethylene glycol. The mixture was stirred for 5 minutes, and then titanium tetraisopropoxide (5 mL) was added, followed by stirring for an additional 5 minutes. Silver nitrate (AgNO₃, 100 mg) dissolved in 2 mL deionized water was added to the mixture, and the reaction mixture was then transferred to a poly(tetrafluoroethylene)-lined stainless steel autoclave. The reaction mixture was heated to a temperature of 205-250° C. for 5-12 hours, and then cooled to room temperature. The precipitate from the reaction mixture was filtered and washed three times with ethanol. All reagents and solvents were obtained from ALDRICH.

### Example 15

### Quaternary Oxide Surface Coating on Glass

A Pd—Ti—O—N quaternary oxide was made by the procedure of Example 13, except that the precipitate was not removed after the autoclave reaction. The suspension was coated onto a clean glass substrate by spin-coating. The substrate was rotated at 1,000 revolutions per minute (rpm) for 10 seconds. The coated glass was then calcined in air for 1 hour at 400° C., with a heating rate of 2° C./min. The thickness of the coating was approximately 5 micometers (μm), as measured by scanning electron microscopy (SEM).

### Example 16

### Quaternary Oxide Surface Coating on Stainless Steel

A Pd—Ti—O—N quaternary oxide was made by the procedure of Example 13, except that the precipitate was not removed after the autoclave reaction. The suspension was separated with a centrifuge to isolate nanofibers of the Pd—Ti—O—N quaternary oxide. Approximately 1 g of the fibers were dispersed in 30 mL of ethanol, and a solution of a coupling agent in ethanol was added to form a coating mixture. The coating mixture was coated onto a stainless steel substrate by spin-coating. The substrate was rotated at 500 rpm for 10 seconds. The coated stainless steel was then calcined in air for 30 minutes. The spin-coating and calcining were repeated 3 times.

Three different coupling agent solutions were examined for the stainless steel coatings:

(a) An aluminum phosphate (AIPO₄) solution was prepared by dissolving 4 g Al(NO₃)₃.9H₂O and 0.5 g P₂O₅ in 20 mL ethanol. The calcining for the surface using this agent was performed at 200° C.

(b) A silane compound solution was prepared by dissolving 3-glycidoxy-propyltrimethoxysilane in ethanol to provide 10 mL of a 2% solution. The calcining for the surface using this agent was performed at 140° C.

(c) A fluoroalkyl-silane compound solution was prepared by dissolving tridecafluoro-1,1,2,2-tetrahydrooctyl)-trichlorosilane in ethanol provide 10 mL of a 2% solution. The calcining for the surface using this agent was performed at 140° C.

### Example 17

### Disinfecting Surfaces

A stainless steel surface coated with a quaternary oxide as described in Example 16 was treated with a culture of bacteria. The surface was then irradiated with visible light, and the percentage of surviving cells was measured over time. The bacteria examined were either Escherichia coli (E. coli), Pseudomonas aeruginosa (P. aeruginosa), Staphylococcus aureus (S. aureus), or bacillus spores.

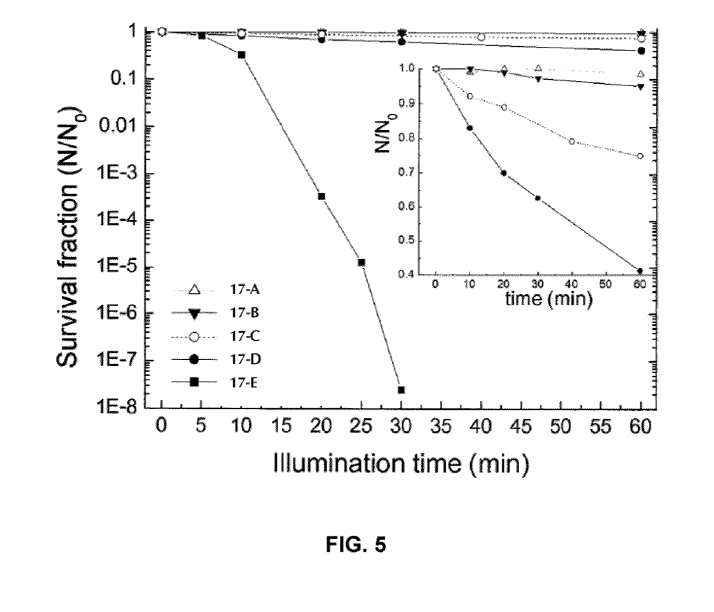

FIG. 5 is a graph of bacteria survival versus time for E. coli on stainless steel surfaces. Surface 17-A was a control surface with no oxide coating. Surface 17-B had a coating of anatase TiO₂ fibers. Surface 17-D had a coating of Ti—O—N. Surfaces 17-C and 17-E each had a coating of Pd—Ti—O—N. Each of the surfaces was exposed to visible light, except for surface 17-C. The surface coated with quaternary oxide and exposed to visible light exhibited the largest reduction in the amount of living bacteria compared to the other surfaces. For this surface, 70% of the bacteria were killed after 10 minutes of exposure, and over 99% of the bacteria were killed after 20 minutes of exposure. The surface coated with Pd—Ti—O—N quaternary oxide but not exposed to visible light also exhibited disinfecting properties, with 15-20% of the bacteria killed after 10 minutes of exposure, and almost 60% of the bacteria killed after 60 minutes exposure.

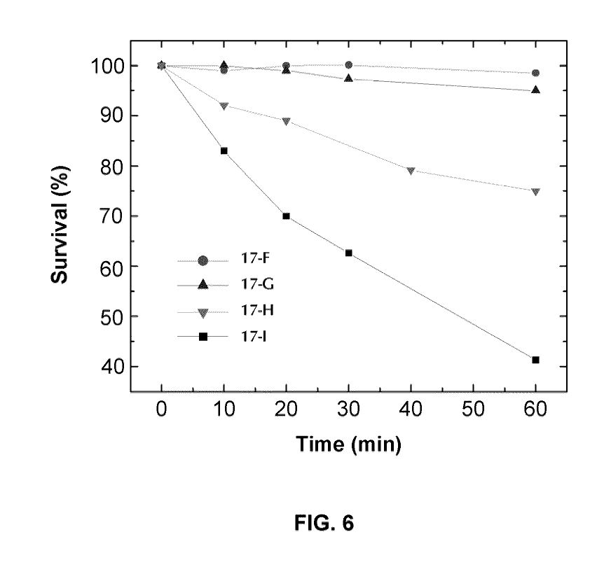

FIG. 6 is a graph of bacteria survival versus time for E. coli on stainless steel surfaces. Surface 17-F was a control surface with no oxide coating, and surface 17-G had a coating of anatase TiO₂ fibers. Surfaces 17-H and 17-I each had a coating of Ag—Ti—O—N. Each of the surfaces was exposed to visible light, except for surface 17-H. The surface coated with quaternary oxide and exposed to visible light exhibited the largest reduction in the amount of living bacteria compared to the other surfaces. For this surface, 15-20% of the bacteria were killed after 10 minutes of exposure, and almost 60% of the bacteria were killed after 60 minutes of exposure. The surface coated with Ag—Ti—O—N quaternary oxide but not exposed to visible light also exhibited disinfecting properties, with almost 10% of the bacteria killed after 10 minutes of exposure, and 20-25% of the bacteria killed after 60 minutes exposure.

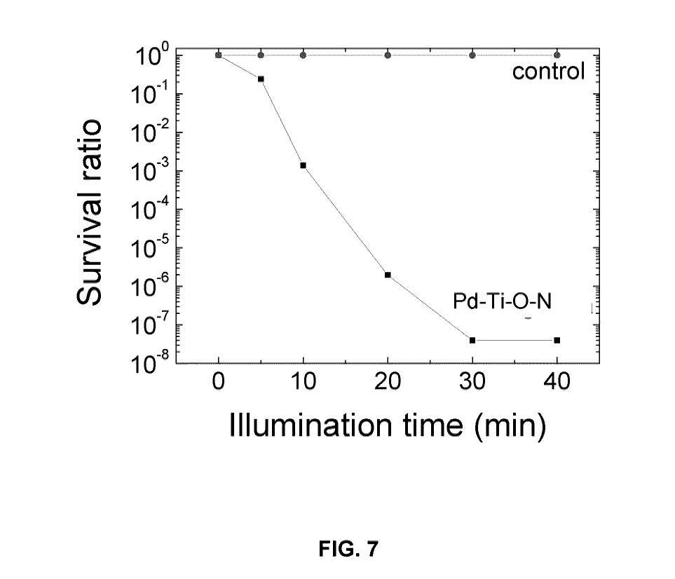

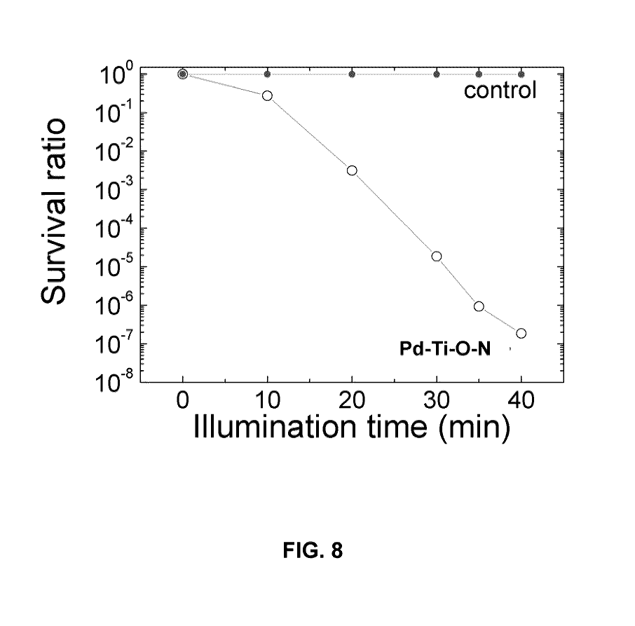

FIGS. 7 and 8 are graphs of bacteria survival versus time on stainless steel surfaces exposed to visible light for P. aeruginosa (FIG. 7) and S. aureus (FIG. 8). A Pd—Ti—O—N quaternary oxide coating was disinfecting for each type of bacteria.

### Example 18

### Self-Cleaning Surfaces

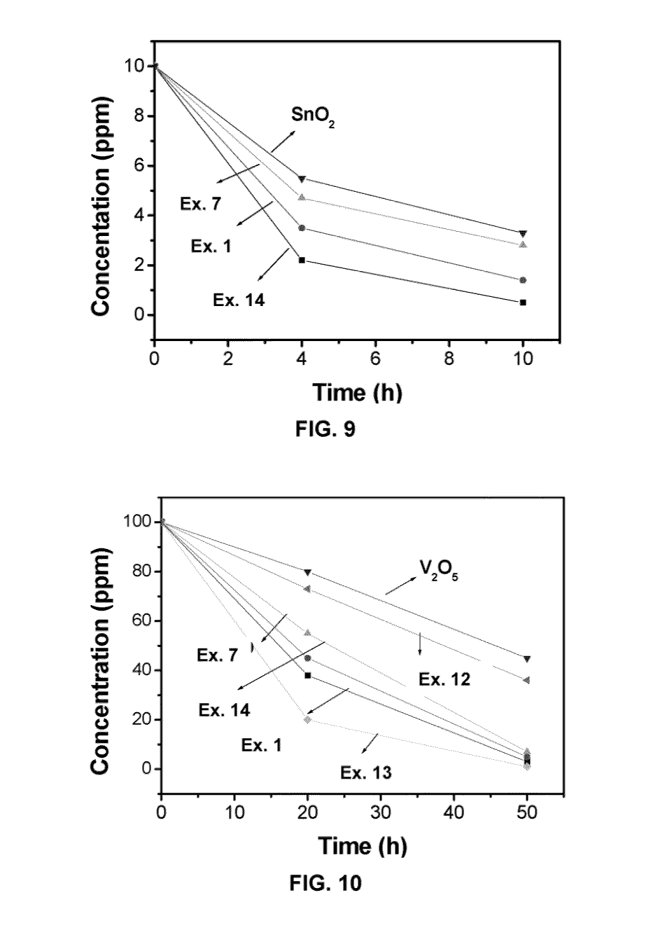

A stainless steel surface coated with a quaternary oxide as described in Example 16 was treated with an organic substance. The surface was then irradiated with visible light, and the concentration of organic material was measured over time. FIG. 9 is a graph of methylene blue concentration versus time for a variety of coated surfaces. The data labeled “SnO₂” was for a surface coated with SnO₂, and the remainder of the data corresponds to surfaces coated with the quaternary oxides from Examples 1, 7 and 14. FIG. 10 is a graph of humic acid concentration versus time for a variety of coated surfaces. The data labeled “V₂O₅” was for a surface coated with V₂O₅, and the remainder of the data corresponds to surfaces coated with the quaternary oxides from Examples 1, 7, 13 and 14 or with the ternary oxide from Example 12.

### Example 19

### Automatic Fingerprint Removal From Surfaces

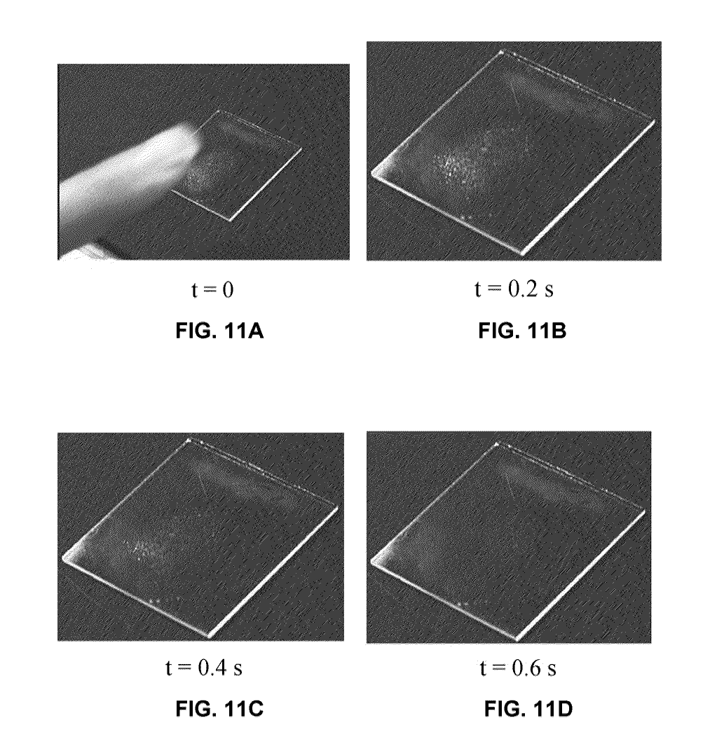

The Pd—Ti—O—N coated surfaces of Example 15 (glass) and Example 16 (stainless steel) were touched with a human finger to deposit a fingerprint. The surfaces were exposed to visible light and monitored for the presence of the fingerprint residue over time. FIGS. 11A-11D are a sequence of images for a glass slide coated with Pd—Ti—O—N. The fingerprint was visibly undetectable within 0.6 seconds of its deposit on the slide.

### Example 20

### Gas Sensing

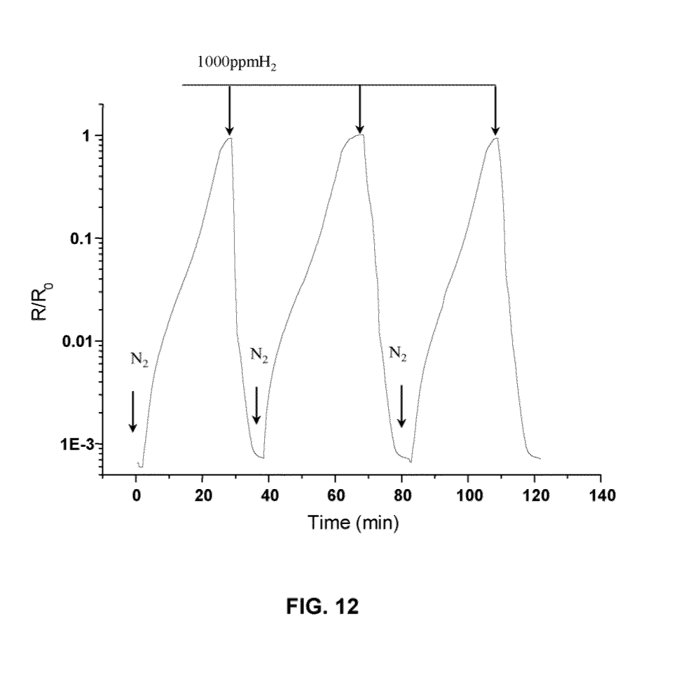

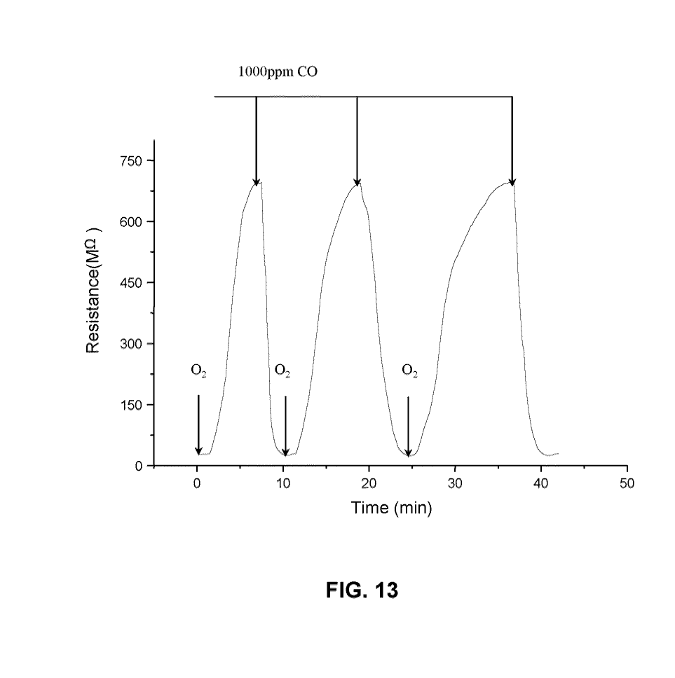

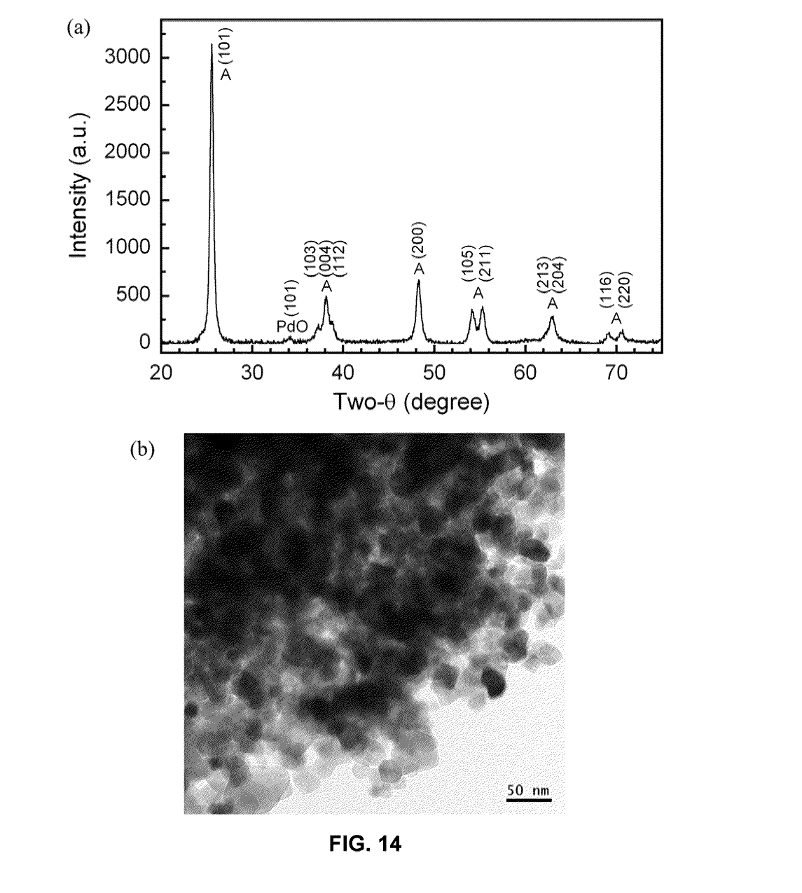

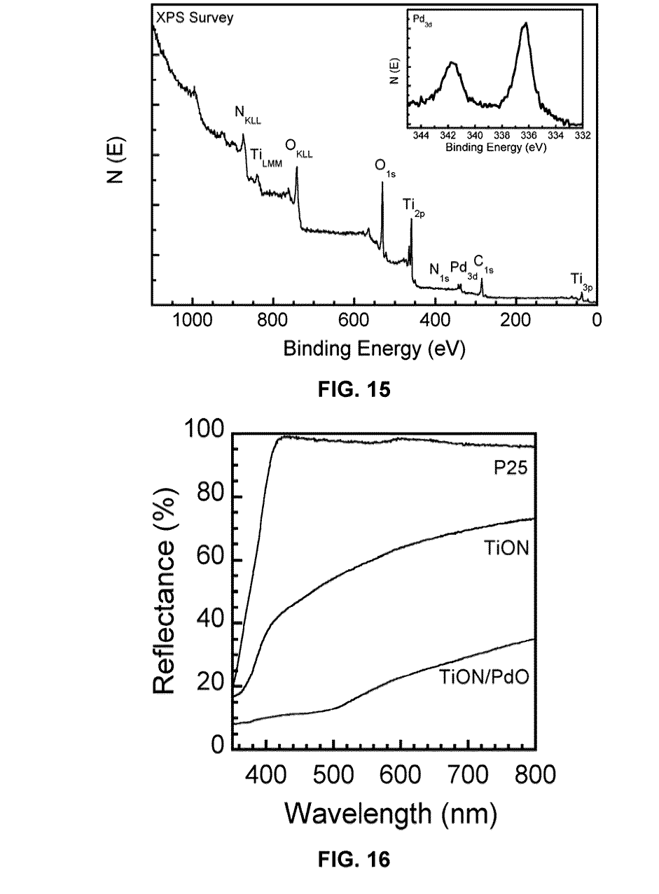

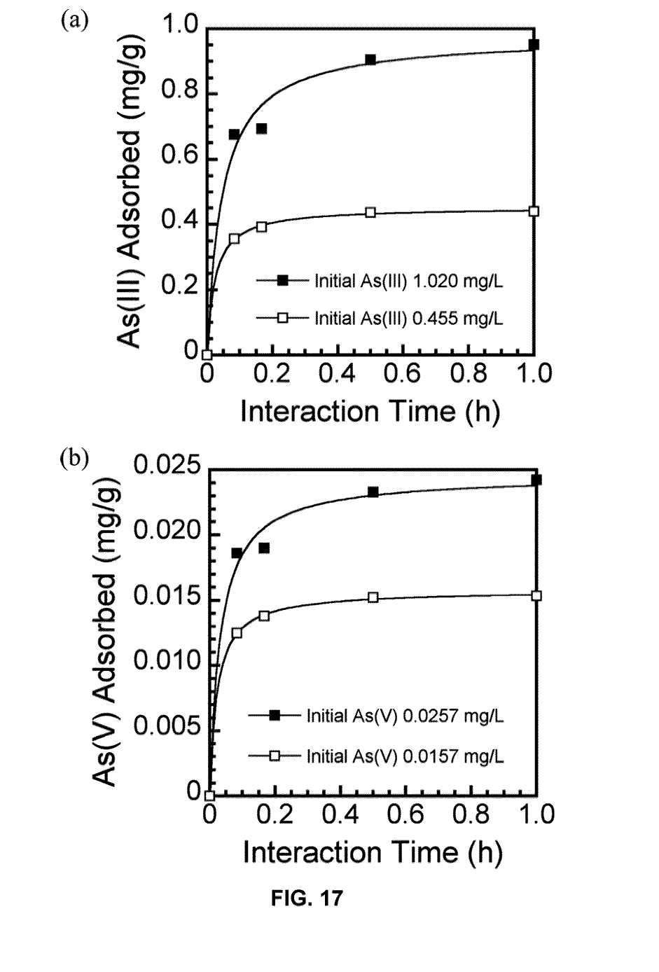

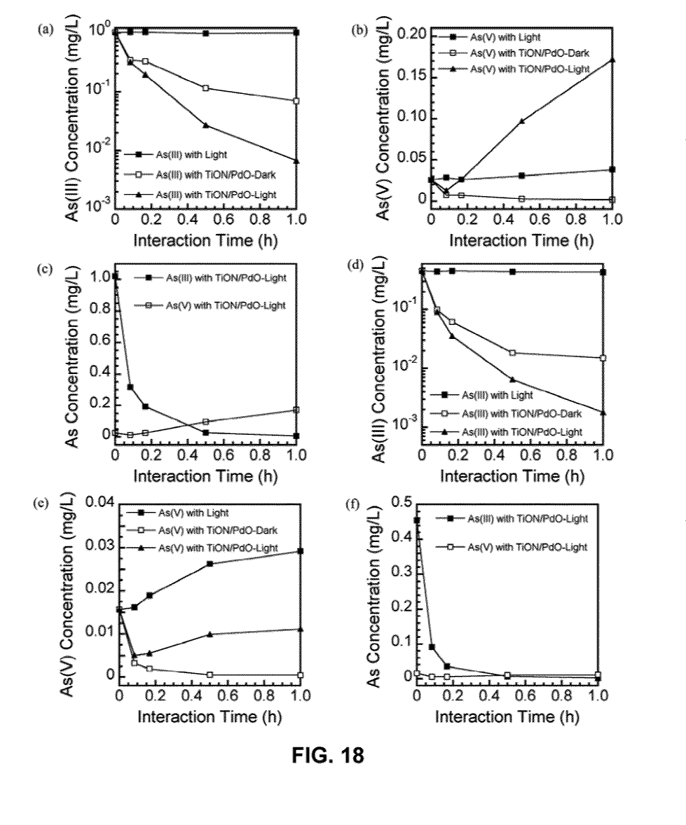

Nanofibers of Pd—Ti—O—N were connected to an ohmmeter and exposed to a variety of gases. The resistance of the fibers increased by 2-3 orders of magnitude when exposed to oxidizable gases such as hydrogen and carbon monoxide. FIG. 12 is a graph of normalized resistance over time, noting the alternate introduction of a nitrogen gas stream (N₂) and a gas stream containing 1,000 ppm hydrogen. The resistance measurements were carried out at 100° C. FIG. 13 is a graph of resistance over time, noting the alternate introduction of an oxygen gas stream (O₂) and a gas stream containing 1,000 ppm carbon monoxide. The resistance measurements were carried out at 200° C.

### Example 21

### Removing Arsenic from Water

In this study, both adsorption and oxidation of As(III) by TiON/PdO nanoparticles (a quaternary titanium oxide) were investigated. TiON/PdO nanoparticles demonstrated a superior performance on both adsorption and oxidation of As(IIII). For the first time, a high degree of As(III) removal under visible light illumination was observed. Over 2 orders of magnitude decrease of As(III) concentration in water was achieved when treated with TiON/PdO nanoparticles under visible light illumination. This technology offers a robust and environmentally benign approach for As(III) removal from water, which is also inexpensive and safe to operate due to the elimination of UV light exposure. Similar results are expected for other quaternary titanium oxides.

Chemicals and Materials

TiON/PdO nanoparticles were prepared by a sol-gel process. Titanium tetraisopropoxide (TTIP, Sigma-Aldrich, St. Louis, Mo.), tetramethylammonium hydroxide (TMA, Sigma-Aldrich, St. Louis, Mo.), and palladium acetylacetonate (Pd(acac)₂, Sigma-Aldrich, St. Louis, Mo.) were used in the sol-gel process as sources of titanium, nitrogen, and palladium, respectively. Ethyl alcohol (EtOH, MPER Alcohol and Chemical Co., Shelbyville, Ky.) and dichloromethane (CH₂Cl₂, Sigma-Aldrich, St. Louis, Mo.) were used as solvents in the sol-gel process. Sodium metaarsenite (NaAsO₂, Sigma-Aldrich, St. Louis, Mo.) was used to prepare As (III) stock solution, and concentrated hydrochloride acid (HCl, 32-38%, Fisher Scientific, Fair Lawn, N.J.) was used to stabilize the arsenic species after treatment.

TiON/PdO Nanoparticle Photocatalyst Fabrication

The TiON/PdO precursor solution was prepared at room temperature by the following sol-gel process. First, TMA was dissolved in EtOH at a molar ratio of 1:10. The solution was stirred magnetically for 5 min, and then TTIP was added into the solution at a TMA/TTIP molar ratio of 1:5. A proper amount of Pd(acac)₂ was dissolved in CH₂Cl₂, and then added into the TMA/TTIP/EtOH mixture to achieve a target Pd/Ti molar ratio at 0.5%. After the mixture was stirred for 5 min, a homogeneous TiON/PdO precursor solution was obtained. It was then loosely covered and the solution was stirred until a homogeneous gel formed. The hydrolysis of precursors was initiated by exposure to moisture in the air. The gel was aged in air for several days to allow further hydrolysis and drying. Then, the xerogel was crushed into fine powder and calcinated in air for 5 h at 500° C. to obtain the desired nanoparticle photoctalysts.

Photocatalyst Characterization

The crystal structure of TiON/PdO nanoparticle photocatalyst was analyzed by X-ray diffraction (XRD) using a Rigaku D-Max X-ray powder diffractometer (Rigaku Corporation, Tokyo, Japan) with Ni-filtered Cu Ka (0.15418 nm) radiation at 45 kV and 20 mA. BET surface area was measured by N₂ adsorption-desorption isotherm with an Autosorb-1 Series surface area and pore size analyzer (Quantachrome Instruments, Boynton Beach, Fla.). X-ray photoelectron spectroscopy (XPS) measurements were made using a Physical Electronics PHI 5400 X-ray photoelectron spectrometer (Perkin-Elmer Corporation, Eden Prairie, Minn.) with a Mg K anode (1253.6 eV photon energy, 15 kV, 300 W) at a takeoff angle of 450. The morphology of the powder was examined by transmission electron microscopy (TEM) on a JEOL 2010LaB6 transmission electron microscope (JEOL Ltd., Tokyo, Japan) operated at 200 kV, with point-to-point resolution of 0.28 nm. TEM samples were made by dispersing a thin film of TiON/PdO powder on a Cu grid. The UV-vis spectra of these powders were measured on a Cary 500 UV/vis/NIR spectrophotometer (Varian, Inc., Palo Alto, Calif.).

As(III) Removal

A stock solution of 0.4 mM (about 30 mg/L) As(III) was prepared by dissolving NaAsO₂ into deionized (DI) water, and stored in the dark in a refrigerator. To investigate the initial As(IIII) concentration effect, the stock solution was diluted to two initial As(III) concentrations (1.02 and 0.455 mg/L) before the As(III) removal experiment, which are in the high range of arsenic species concentrations found in natural water around the world (2). Their pH value was about 7.5, near the neutral state. A fixed concentration of 1 mg photocatalyst/mL arsenic solution was used in the study. During the experiment, the arsenic solution was stirred magnetically to disperse TiON/PdO nanoparticles to ensure a good contact of TiON/PdO with the arsenic species. The glass-covered plastic cup was illuminated by a metal halogen lamp with a glass filter to maintain a zero light intensity below 400 nm. The light intensity striking the arsenic solution was ca. 1.0 mW/cm². The illumination time varied from 5 min to 1 h. To examine both the adsorption capability in dark and photocatalytic oxidation effect with visible light illumination, the As(III) removal experiments were conducted with and without the visible light illumination in the presence of TiON/PdO, respectively. For comparison, As(III) solution was also treated just by visible light illumination. After recovering the photocatalyst by centrifugation, one drop of concentrated HCl was added into the clear solution to preserve its arsenic species. Then the samples were sent to the Illinois Sustainable Technology Center for the arsenic speciation analyses to determine the concentrations of As(III) and As(V) species with a HPLC-ICPMS system the next day.

HPLC-ICPMS System Set Up

The analyte and mobile phase (2.5 mM oxalic acid) were initially filtered and sparged. The internal standard was 150 ppb yttrium, and a 30 μL loop was used. The column was primed overnight, and then a calibration curve was created before the analytes were analyzed. Speciation for arsenite (As(III)) and arsenate (As(V)) was achieved by coupling an IonPac AS 11 column to the sample introduction system of a VG Elemental PQ Excell Inductively Coupled Plasma Mass Spectrometer. The radiofrequency had a forward power of 1350 W. The argon cool gas flow rate was 15 L /min, and the auxiliary argon gas flow was 1 L /min. The sample introduction system consists of an Acuflow Series IV Pump, a PrepLab sampling station, a Gilson autosampler, a Perimax 12 peristaltic pump, which delivers the sample at a rate of 1 ml /min, and a Conikal quartz nebulizer attached to a glass ARL mini spray chamber.

TABLE 1
Kinetics parameters for As (III) and As (V) adsorption onto
TiON/PdO nanoparticles.

| | As (III) | | As (V) | |
|---|---|---|---|---|
| Initial | 1.02 | 0.455 | 0.0257 | 0.0157 |
| Concentration | | | | |
| (mg/L) | | | | |
| qₑ (mg g⁻¹) | 0.9763 | 0.4522 | 0.0245 | 0.0157 |
| K_{ad} (mg g⁻¹ h⁻¹) | 22.297 | 95.87 | 1256.3 | 2865.4 |
| R² | 0.9865 | 0.9997 | 0.9907 | 0.9998 |
| MWSE | 0.00157 | 8.736 × 10⁻⁶ | 7.203 × 10⁻⁷ | 7.023 × 10⁻⁹ |

Crystal Structure and Morphology of TiON/PdO Nanoparticles

FIG. 1 a shows the X-ray diffraction pattern of TiON/PdO nanoparticles. It demonstrates that only anatase phase is present, and no rutile phase exists. Besides the anatase-type structure, a weak diffraction peak was identified which could be assigned to PdO (101) XRD diffraction peak. This observation suggests that palladium additive exists as PdO at a very small quantity and is not incorporated into the anatase structure, which is the reason to name this material system TiON/PdO. The crystallite size of the anatase phase is about 23 nm, obtained from the strongest XRD peak (at 2θ about 25.5° for anatase phase) by Scherrer's formula (39):

D=0.9λ/β cos θ (1)

where λ is the average wavelength of the X-ray radiation, β is the line-width at half-maximum peak position, and θ is the diffracting angle.

FIG. 1b shows the TEM image of TiON/PdO nanoparticles. They are nanosized particles with nonuniform shapes, and the average particle size is around 20-30 nm. The BET surface specific area of these nanoparticles is found to be 53.39 m²/g, corresponding to an average particle diameter about 29 nm, close to the calculated anatase phase crystallite size and the TEM observation.

Composition of TiON/PdO Nanoparticles

FIG. 2 shows the representative XPS survey spectrum, which confirms the presence of Ti, O, N, and Pd in the sample. C 1s peak was also observed due to the widespread presence of carbon in the environment. The relative element composition ratio was determined by multiplex high-resolution scans over N 1s, O 1s, Pd 3d, and Ti 2p spectral regions. An average N/Ti atomic ratio of about 0.06 was found. The inset plot is the high-resolution scan over Pd 3d spectral region. The binding energy of Pd 3d_{5/2} is about 336.20 eV, suggesting that Pd additive exists as PdO in TiON/PdO nanoparticles and is in agreement with the XRD analysis.

Optical Properties of TiON/PdO Nanoparticles

The optical properties of TiON/PdO nanoparticles were investigated by measuring the diffuse reflectance spectrum. FIG. 3 shows the diffuse reflectance spectrum of TiON/PdO nanoparticles, compared with both Degussa P25 TiO₂ nanoparticles and TiON nanoparticles with similar nitrogen dopant concentration. Degussa P25 (Evonik Industries, Essen, Germany) is a commercially available TiO₂ powder widely studied in photocatalysis. TiON nanoparticles were synthesized with the same procedures as TiON/PdO nanoparticles, only without the addition of palladium precursor. Degussa P25 shows the characteristic spectrum of TiO₂ with the fundamental absorbance stopping edge at about 400 nm. TiON nanoparticles show a clear shift into the visible light range (>400 nm) as expected, which can be attributed to the nitrogen doping effect (35). TiON/PdO nanoparticles show higher visible light absorption compared with TiON nanoparticles, suggesting that Pd modification further promotes the visible light absorption in TiON nanoparticle photocatalysts. This enhanced visible light absorption could be attributed to the optoelectronic coupling between PdO and TiON (37).

As(III) Removal by TiON/PdO Nanoparticles

Due to the short life-times of both photon-excited electron-hole pairs and subsequently produced radicals such as .OH, O₂.⁻, and HO₂., the photocatalytic reactions occur only at/near the photocatalyst surface. Thus, it is essential that photocatalysts have a good adsorption capability to As(III) (30). It has been demonstrated previously that TiO₂ could be an effective adsorbent for arsenic species (30, 40-44). We first investigated the adsorption capability of TiON/PdO nanoparticles. The experiments were carried out with TiON/PdO nanoparticles in dark to ensure no photocatalytic interaction occurred, and the results are demonstrated in FIG. 4 by the amount of arsenic species adsorbed to TiON/PdO in the unit of mg of arsenic species/g of TiON/PdO versus the adsorption time. Arsenic species (both As(III) and As(V)) could be adsorbed onto TiON/PdO nanoparticles in a short time. For example, around 66.2% As(III) in the solution was adsorbed in just 5 min when the initial As(III) concentration was 1.02 mg/L, and only 6.78% As(II) was still in the treated solution after 1 h. With the decrease of the initial arsenic species concentration, the TiON/PdO to arsenic species ratio increases and even higher adsorption efficiency was observed.

The changes of arsenic concentration in solutions are summarized in FIG. 5. FIGS. 5a-c are results from samples with an initial As(lII) concentration of 1.02 mg/L, while FIGS. 5d-f are results from samples with an initial As(III) concentration of 0.455 mg/L. FIG. 5a shows the residue concentration of As(III) after three different treatments. With only visible light illumination, not much difference was observed on the concentration of As(III). This observation suggests that not much As(III) could be oxidized with visible light alone. Although our TiON/PdO nanoparticles possess a good adsorption capability on As(III), the remaining As(III) concentration after 1 h adsorption was still at 69.1 μg/L, higher than the 10 μg/L USEPA standard for drinking water. Further decrease of As(III) was observed when both TiON/PdO nanoparticles and visible light illumination were present. At the beginning of the illumination, the adsorption of As(III) onto TiON/PdO nanoparticles still played the major role. With the increase of the illumination time, more and more difference was observed in As(III) removal. After 1 h visible light illumination, the remaining As(III) concentration was at 6.7 μg/L, which represents another magnitude degree of decrease over the pure adsorption effect and is lower than the 10 μg/L limit. Thus, the TiON/PdO photocatalysts enable removal of As(III) by oxidizing it to As(V) under visible light illumination, which is clearly demonstrated in FIG. 5b.

FIG. 5b shows the changes of As(V) concentration under these three treatments in details, respectively. Under only visible light illumination, the As(V) concentration showed a slight increase with time up to 1 h due to the As(lII) oxidation when exposed to the air. When TiON/PdO nanoparticles were present without visible light illumination, the concentration of As(V) decreased sharply due to its adsorption onto TiON/PdO nanoparticles. After 1 h interaction, the As(V) concentration decreased from 25.7 to 1.5 μg/L, representing a 94.2% decrease. With visible light illumination, the As(V) concentration dipped initially, which could be attributed to the combination effects from both As(V) adsorption (decreasing the As(V) concentration) and As(lII) oxidation (increasing the As(V) concentration), while As(V) adsorption plays the major role in the initiation of the interaction. With the increase of the illumination time, a significant increase of As(V) concentration was observed. This increase could only be attributed to the continuous generation of As(V) from the photooxidation of As(III) by the photocatalytic TiON/PdO nanoparticles, which overrides the decrease of As(V) concentration by adsorption. Thus, our experiment here provides clear evidence that As(III) could be oxidized into As(V) under visible light illumination with proper photocatalysts in presence, which thus eliminates the requirement for an expensive/possibly hazardous UV light source for TiO₂ photooxidation on As(III).

FIG. 5c summarizes the As(III) and As(V) concentration changes under visible light illumination in the presence of TiON/PdO nanoparticles. As(III) concentration decreased largely due to the combination of effects from both adsorption and photooxidation. Unlike some previous reports on the TiO₂ photooxidation of As(III) under UV light illumination (24, 32), the apparent conversion of As(III) to As(V) in our experiment is not very high, far from near complete conversion. This difference is due to the excellent adsorption capability of TiON/PdO nanoparticles on As(V), which largely decreases the As(V) concentration in the treated solution in spite of the continuous generation of As(V) by the photooxidation of As(III).

FIGS. 5d-f show the results from the lower initial As(III) concentration at 0.455 mg/L, which demonstrates the trend similar to that of the higher initial As(III) concentration at 1.02 mg/L. The relative higher increase of the As(V) concentration with only visible light illumination in FIG. 5e than that in FIG. 5b is due to the lower initial As(V) concentration. Due to the relatively higher TiON/PdO nanoparticle photocatalyst loading, only 3.27% As(III) and 2.33% As(V) were still in the treated solution after 1 h adsorption in the dark. After 1 h visible light illumination in the presence of TiON/PdO nanoparticles, the As(III) concentration dropped to 1.8 μg/L, much smaller than the 10 μg/L limit. The As(V) concentration in the presence of TiON/PdO nanoparticles under illumination also showed an initial decrease, due to the strong adsorption effect, followed with an increase attributed to the generation of As(V) from the photooxidation of As(III). Because of the lower As(III) initial concentration and higher adsorption efficiency of TiON/PdO on arsenic species under relatively higher material loading, the residue As(V) concentration in the treated solution was still lower than its initial value even after 1 h illumination.

While various embodiments of the invention have been described, it will be apparent to those of ordinary skill in the art that other embodiments and implementations are possible within the scope of the invention. Accordingly, the invention is not to be restricted except in light of the attached claims and their equivalents.

1. A method of purifying water, comprising:
contacting the water with a quaternary oxide while exposing the quaternary oxide to visible light, the quaternary oxide containing:
a dopant metal,
a dopant nonmetal,
titanium, and
oxygen;
where the atomic ratio of titanium, oxygen and dopant nonmetal is 1:0.5-1.99:0.01-1.5.

2. The method of claim 1, where the dopant metal is present in the oxide at a concentration of at most 10 percent by weight.

3. The method of claim 1, where the dopant metal is present in the oxide at a concentration of at most 5 percent by weight.

4. The method of claim 1, where the dopant metal is present in the oxide at a concentration of at most 2 percent by weight.

5. The method of claim 1, where the dopant metal is selected from the group consisting of calcium, cobalt, nickel, copper, gallium, strontium, yttrium, zirconium, palladium, silver, tin, lanthanum and platinum.

6. The method of claim 1, where the dopant nonmetal is selected from the group consisting of boron, carbon, nitrogen, sulfur and fluorine.

7. The method of claim 1, where the dopant nonmetal is nitrogen.

8. The method of claim 5, where the dopant nonmetal is nitrogen.

9. The method of claim 1, where the atomic ratio of titanium, oxygen and dopant nonmetal is 1:1.0-1.99:0.01-1.0.

10. The method of claim 1, where the atomic ratio of titanium, oxygen and dopant nonmetal is 1:1.5-1.99:0.01-0.5.

11. The method of claim 1, where the atomic ratio of titanium, oxygen and dopant nonmetal is 1:1.9-1.99:0.01-0.1.

12. The method of claim 1, where the band gap of the quaternary oxide is less than 3.0 eV.

13. The method of claim 1, where the water contains arsenic.

14. A method of oxidizing As(III) to As(V), comprising:
contacting a solution containing As(III) with a quaternary oxide while exposing the quaternary oxide to visible light, the quaternary oxide containing:
a dopant metal,
a dopant nonmetal,
titanium, and
oxygen;
where the atomic ratio of titanium, oxygen and dopant nonmetal is 1:0.5-1.99:0.01-1.5.

15. The method of claim 14, where the dopant metal is present in the oxide at a concentration of at most 10 percent by weight.

16. The method of claim 14, where the dopant metal is present in the oxide at a concentration of at most 5 percent by weight.

17. The method of claim 14, where the dopant metal is present in the oxide at a concentration of at most 2 percent by weight.

18. The method of claim 14, where the dopant metal is selected from the group consisting of calcium, cobalt, nickel, copper, gallium, strontium, yttrium, zirconium, palladium, silver, tin, lanthanum and platinum.

19-25. (canceled)

26. A method of removing arsenic from water, comprising:
contacting the water with a quaternary oxide while exposing the quaternary oxide to visible light, the quaternary oxide containing:
a dopant metal,
a dopant nonmetal,
titanium, and
oxygen;
where the atomic ratio of titanium, oxygen and dopant nonmetal is 1:0.5-1.99:0.01-1.5, and
the dopant nonmetal is nitrogen.

27-35. (canceled)

36. A catalyst for oxidizing As(III) to As(V), containing:
a dopant metal,
a dopant nonmetal,
titanium, and
oxygen;
where the atomic ratio of titanium, oxygen and dopant nonmetal is 1:0.5-1.99:0.01-1.5, and
the dopant nonmetal is nitrogen.

37-45. (canceled)
